(19) United States
(12) Patent Application Publication
(10) Pub. No.: US 2012/0017798 A1
(43) Pub. Date: Jan. 26, 2012

(54) TRACK SYSTEM FOR A MAGNETIC LEVITATION VEHICLE

(76) Inventor: Reiner Koehler, Fuerstenfeldbruck (DE)

(21) Appl. No.: 13/145,470

(22) PCT Filed: Nov. 17, 2009
(86) PCT No.: PCT/DE09/01613

§ 371 Date: Jul. 20, 2011

(30) Foreign Application Priority Data
Jan. 23, 2009 (DE) 10 2009 006 027.8

(51) Int. Cl. B60L 13/04

(52) U.S. Cl. 104/286

(57) ABSTRACT

The invention relates to a track system for a magnetic levitation vehicle, comprising stator carriers (9) and stator assemblies (1) attached there-to by way of cross beams. In order to prevent the stator assemblies (1) from falling off the stator carriers (9) in the event of a failure of the fastening bolts, securing means are provided, which have spacer sleeves (14) extending through select cross beams (16) and bolts (15) extending through said sleeves (14). The axial length (L) of the spacer sleeves (14) is greater than the thickness (D) of the select cross beams (16), so that in the event of a failure of the fastening bolts used to fasten the stator assemblies (1) to the stator carrier (9), said cross beams (16) can drop by no more than a dimension that corresponds to the difference between the dimensions (L) and (D).

The invention relates to a track system of the type described in the preamble of claim 1.

Track systems made of concrete or steel for magnetic levitation vehicles (e.g. DE 34 04 061 C1, DE-Z “Zeitschrift für Eisenbahn und Verkehr, Glasers Annalen” [Glaser's Annals: Publication for Railways and Traffic Engineering] 105, 1981, No. 7/8, pages 205 to 215) include a large number of carriers arranged one after the other along a route, on which equipment such as lateral guide rails, slider strips, and stator assemblies are mounted. Fastening screws are used to attach the equipment to the carriers, wherein said fastening screws extend through holes in the equipment, are screwed into threaded holes in the carriers, and rest via heads thereof against the equipment.

Particular attention must be given to attaching the stator assemblies which form components of a long-stator linear motor used to drive the magnetic levitation vehicles, and which are typically fastened from the bottom to stator carriers which are connected to the carriers. In the event of failure of the fastening screws, the stator assemblies can become detached from the stator carriers and fall downward, which should be prevented.

To prevent this disadvantage, each stator assembly is usually equipped with at least two so-called cross beams which extend transversely to the stator assemblies and are fastened to the applicable stator carrier using two fastening screws in each case. In order to completely rule out a failure of the fastening screws, they would have to satisfy the highest quality requirements, which would not be economical given the large number of screws required (e.g. a few thousand per kilometer of track system). Moreover, as a safety measure, the fastening screws would have to be inspected at frequent time intervals, which would increase the operating costs to a considerable extent.

Track systems of the initially described type have therefore already been made known (e.g. DE 39 28 278 C2, DE 202 10 808 U1), which comprise redundant and diversified fastening systems for the stator assemblies. These fastening systems are equipped with securing means which take effect in the event of failure of the fastening screws by permitting a defined displacement of the cross beams to occur, e.g. 1 mm to 2 mm, relative to the applicable stator carrier, while also reliably preventing the stator assemblies from becoming completely detached from the stator carrier. The magnitude of the displacement is advantageously selected such that vehicle operation can be maintained, at least for a short period of time, and such that the displacement is visible and can be automatically detected and reported to the general master operating system by way of distance sensors, or the like, which are installed in the magnetic levitation vehicles.

Securing means of this type are known, such as recesses formed in the carrier, into which projections engage with a preselected amount of play (DE 39 28 278 C2). In the event of failure of the fastening screws, which would cause the cross beams to fall downward, these projections can become displaced in the recesses only by the preselected amount of play, in which case they come to rest against the wails enclosing the recesses, thereby halting the fall of the cross beams. Alternatively, it is known to equip the cross beams on their top sides facing the stator carriers with dovetail-shaped or T-shaped cross sections and to situate them with a preset amount of play in appropriately shaped grooves formed in the undersides of the stator carriers (e.g. DE 202 10 808 U1). If the fastening screws should fail, the cross beams can drop into the grooves by no more than the amount of preselected play, thereby enabling the failure of the fastening screws to be detected and measured.

The securing means provided previously for these purposes are complex to produce and assemble, and, in part, pose an impediment to easy installation and expansion of the stator assemblies.

Proceeding therefrom, the technical problem addressed by the present invention is that of designing the track system of the initially described type such that the securing means are easy to produce and assembly thereof is simplified.

This problem is solved according to the invention by the characterizing features of claim 1.

The invention makes it possible to use typical fastening screws to attach the cross beams to the stator carriers and to produce the securing means described. Only one additional spacer sleeve is required at the point where securing means should be provided, thereby greatly reducing the portion of production costs allocated to the securing means. In addition, all fastening screws can be connected to the stator carrier in the same manner, thereby greatly simplifying the installation of the stator assemblies.

Further advantageous features of the present invention will become apparent from the dependent claims.

The invention is explained below in greater detail with reference to the attached drawings of embodiments. In the drawings:

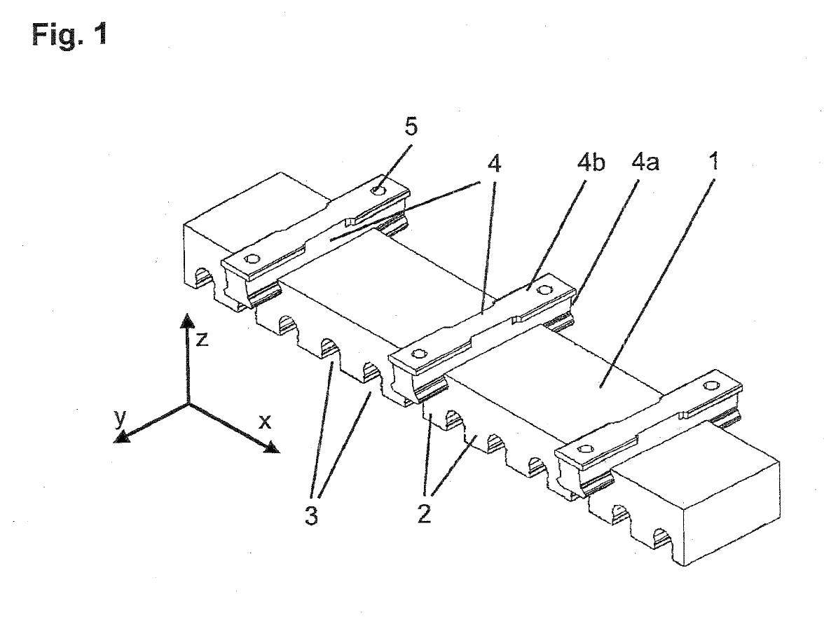

FIG. 1 shows a perspective depiction of a typical stator assembly for the track system of a magnetic levitation vehicle;

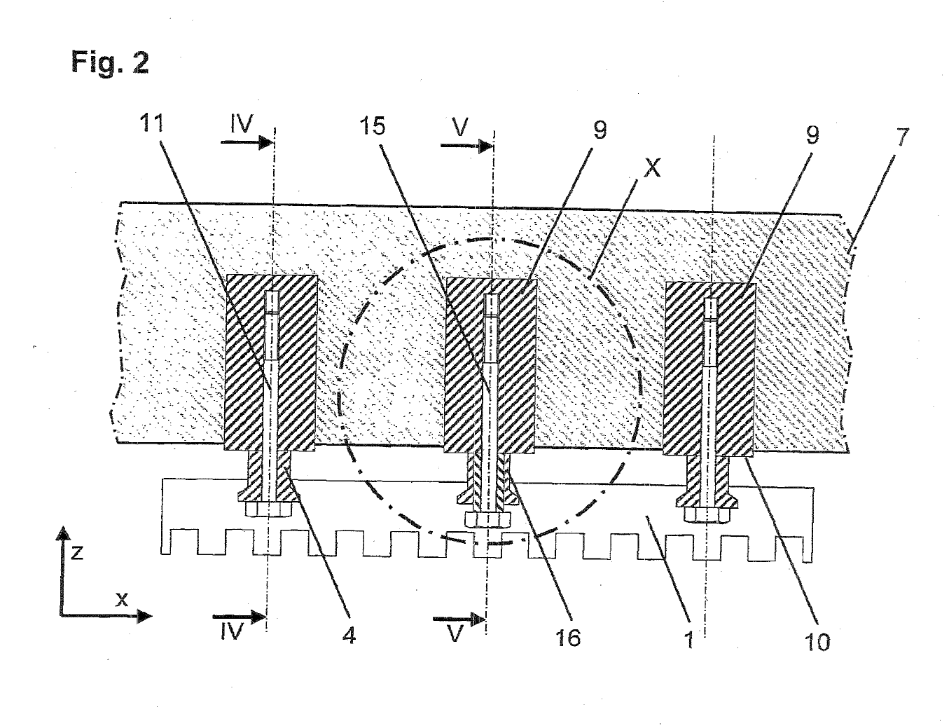

FIG. 2 shows a longitudinal sectional view of a first embodiment of a track system section for a magnetic levitation vehicle, which is equipped with a securing means according to the invention;

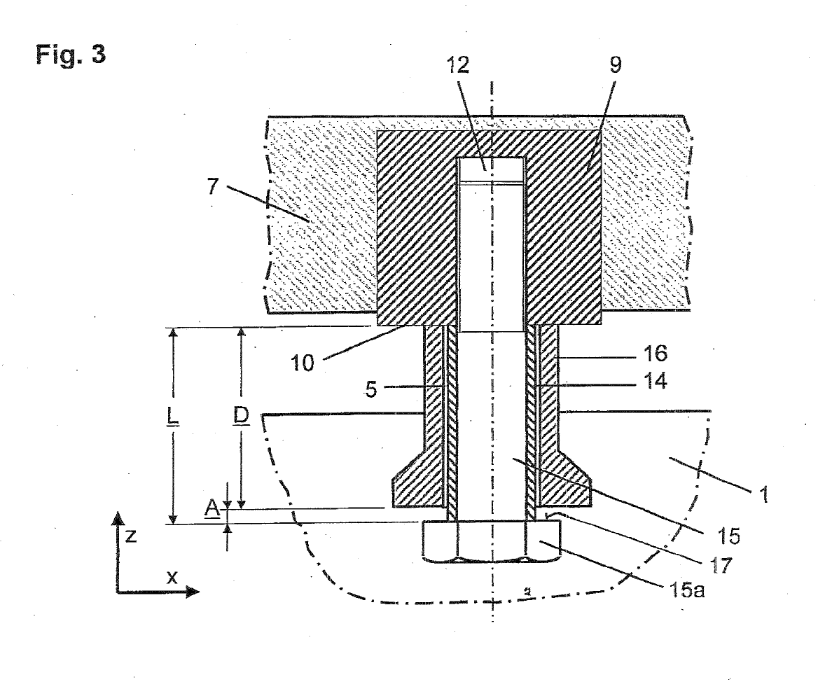

FIG. 3 shows a greatly enlarged detail X of FIG. 2;

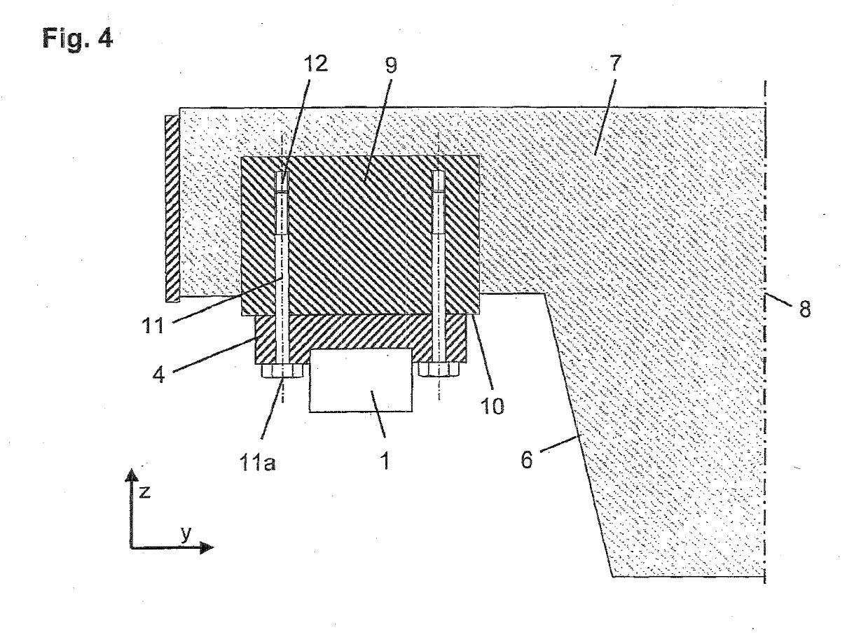

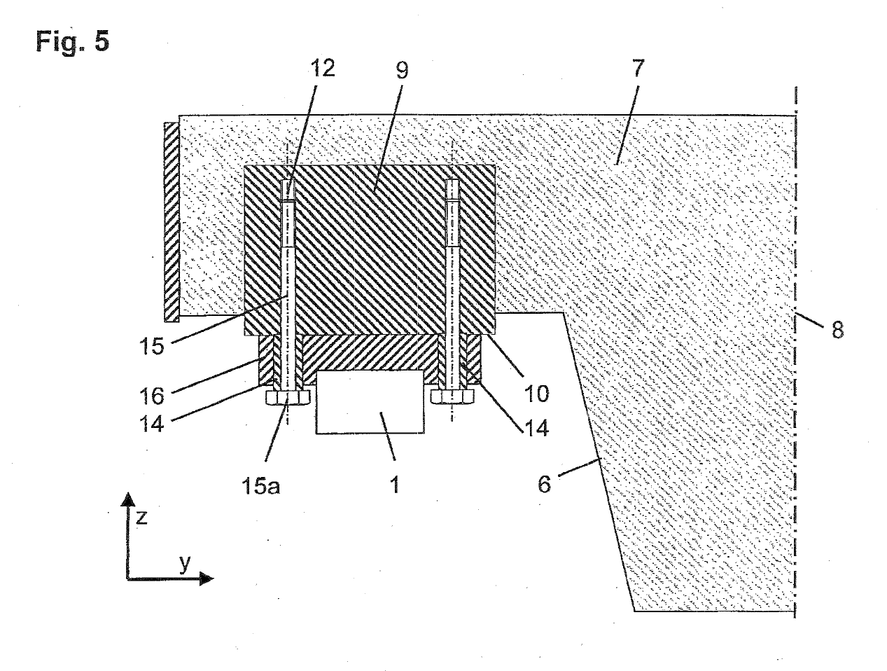

FIGS. 4 and 5 show cross sections along lines IV-IV and V-V in FIG. 2, in conjunction with a carrier of the track system;

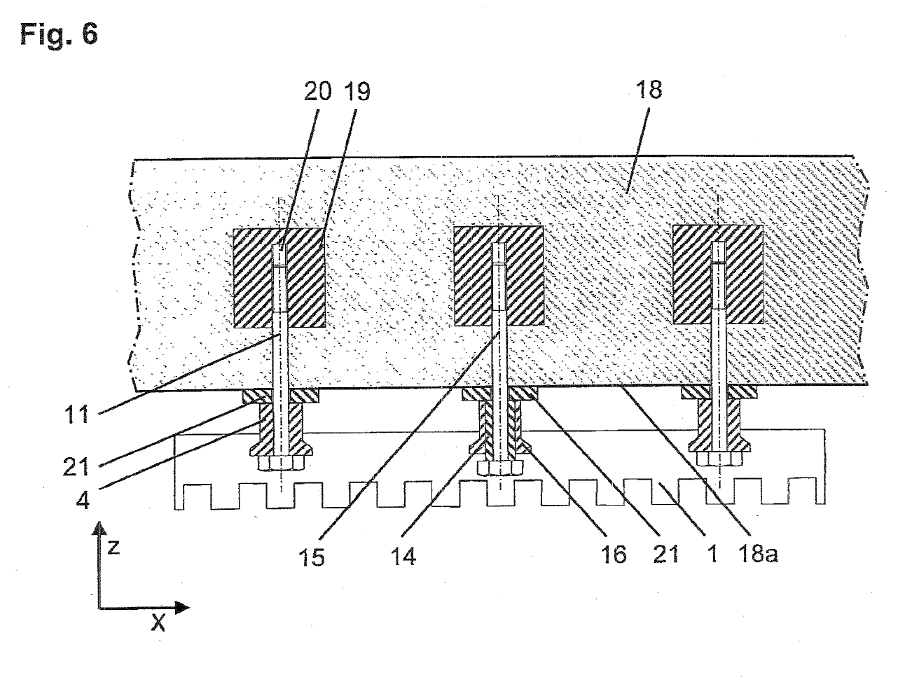

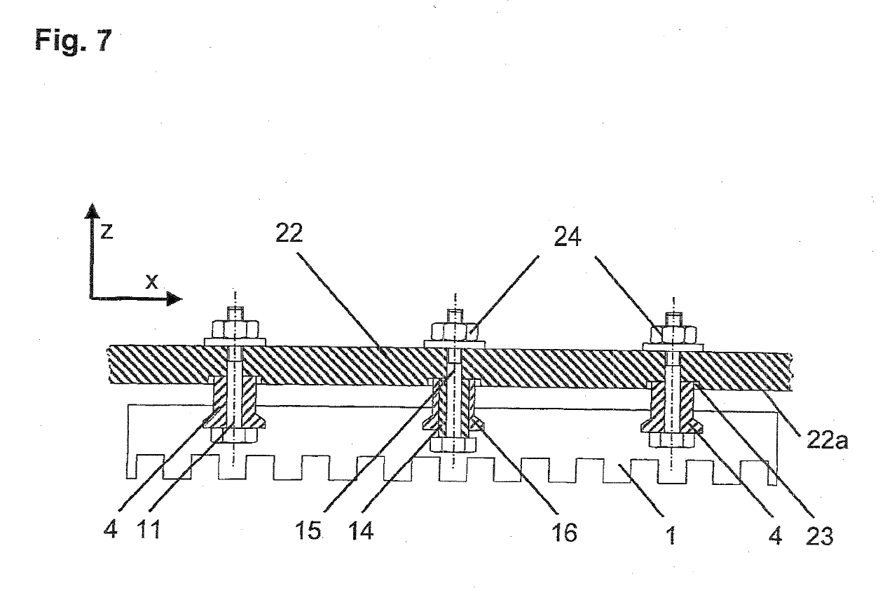

FIGS. 6 and 7 show two views, which correspond to FIG. 2, of two further track system sections for a magnetic levitation vehicle, which are equipped with the securing means according to the invention; and

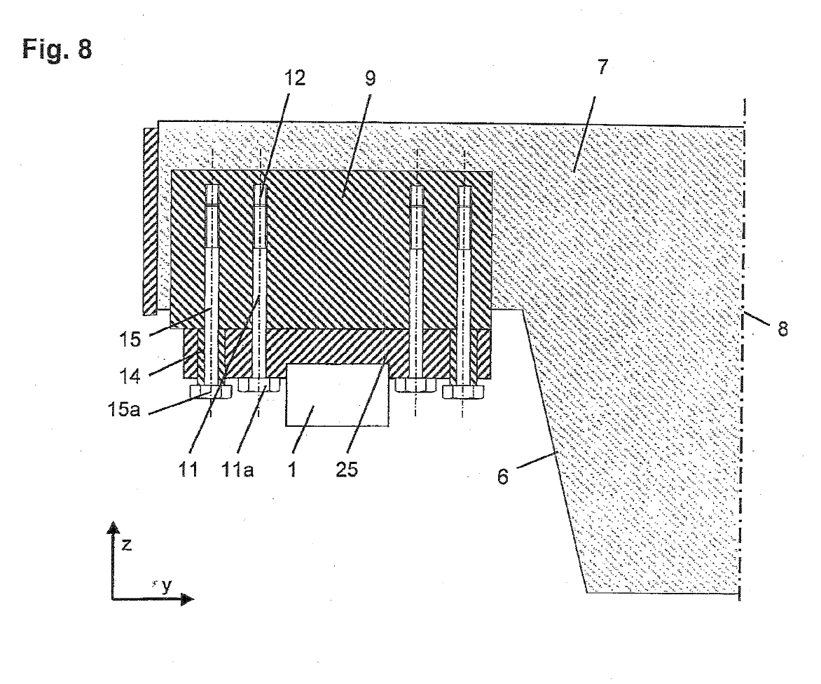

FIG. 8 shows a section—which corresponds to FIGS. 4 and 5—of a track system section for a magnetically levitated vehicle, wherein the securing means according to the invention are disposed in a manner that differs from that depicted in FIGS. 2 to 7.

The track systems of magnetically levitated vehicles driven by a long-stator linear motor are equipped with a large number of stator assemblies 1 which are composed of pieces of sheet metal and are disposed one behind the other in a direction of travel which is generally defined as line parallel to the x-axis of an imagined coordinate system. The x-direction simultaneously indicates the longitudinal direction of an imagined route along which the track system is placed. Stator assemblies 1 are 1 m or 2 m long, for example, and comprise on the underside thereof teeth 2 and grooves 3 which alternate in a preset grid spacing, and which are used to accommodate typical motor windings which are not depicted. On the top side thereof, stator assemblies 1 are securely connected to slot elements or cross beams 4 which extend parallel to the y-direction of the imagined coordinate system. Cross beams 4 are equipped at the two ends thereof with head pieces 4a that extend beyond stator assemblies 1 and comprise passages 5. Passages 5 are used to receive fastening screws and, in the installed state of cross beams 4, extend substantially parallel to the z-direction of the imagined coordinate system.

Stator assemblies of this type are known, inter alia, from document DE 197 03 497 A1, and the attachment thereof to a track system is described in aforementioned documents DE 39 38 278 C2 and DE 202 10 808 U1, for example. All of these documents are therefore made the subject matter of the present disclosure by reference thereto, to avoid repetition.

The redundant and diversified fastening system for stator assemblies 1 according to the invention, which is currently considered to be the best, is shown in FIGS. 2 to 5. According thereto, the track system is composed of a plurality of carriers 6 (FIGS. 4 and 5) made of concrete, which comprise laterally projecting cantilever arms 7 extending in the y-direction, which are disposed with mirror symmetry relative to a center plane 8 extending in the z-direction. Since the configuration is the same on either side of center plane 8, FIGS. 4 and 5 show only one of the two cantilever arms 7.

Individual connecting elements or inserts 9, which are made of steel and are referred to below as stator carriers, are permanently installed in cantilever arms 7 which are made of concrete. In the embodiment, stator carriers 9 have first stop surfaces 10 on lower ends which extend out of the cantilever arms, and which have been machined using computer-controlled tools, in particular milling tools, in a manner that is exact and is appropriate for the shape of the particular route. In particular, first stop surfaces 10 of as many inserts 9 as there are cross beams 4 on stator assemblies 1 lie in a common plane. In the embodiment, each stator assembly 1 comprises three cross beams 4 which are interspaced in the direction of travel, i.e. the x-direction. Stator carriers 9 are disposed in cantilever arms 7 at corresponding distances, wherein each stator carrier 9 has a length in the y-direction that corresponds to the length of cross beams 4, as shown in FIGS. 4 and 5.

Cross beams 4 comprise, on the top sides thereof, in particular in the region of head pieces 4a thereof, second stop surfaces 4b (FIG. 1) which are likewise fiat. They are placed against first stop surfaces 10 of stator carriers 9 during assembly of the track system, wherein the placement is selected such that, when cross beams 4 are placed against stop surfaces 10, the correct position of applicable stator assembly 1 in three dimensions is automatically attained.

Cross beams 4 and, therefore, stator assemblies 1 are attached to stator carriers 9 using first fastening screws 11. They are inserted through passages 5 formed in head pieces 4a of cross beams 4, and are screwed into threaded holes 12 (FIG. 4) formed in stator carriers 9. Heads 11 a of fastening screws 11 thereby rest against cross beams 4 from the bottom. Furthermore, fastening screws 11 are screwed into threaded holes 12 with the required preload.

According to the invention, securing means which contain spacer sleeves 14 and second fastening screws 15 (FIGS. 3 and 5) are assigned to stator assemblies 1 or selected cross beams 5 thereof. These selected cross beams are labelled with reference numeral 16 in FIGS. 2 to 5. Spacer sleeves 14 are inserted into passages 5 of these selected cross beams 16 and have an axial length (L) (FIG. 3) in the z-direction that is greater than a thickness D of cross beams 16 at the points containing passages 5. For assembly, spacer sleeves 14 are first inserted into passages 5 in cross beam 16, and then second fastening screws 15 are inserted and screwed into threaded holes 12 of associated stator carrier 9. As a result, spacer sleeves 14 rest by way of first—upper, as shown in FIG. 3—ends against stop surfaces 10 of stator carriers 9, while the second—lower, as shown in FIG. 3—ends thereof rest on heads 15a of second fastening screws 15. Dimensions L and D are preferably selected such that, in the installed state, a difference A (FIG. 3) results which defines the displacement or the amount by which a cross beam 4—which is attached only by second fastening screws 15 and has the same thickness D—can fall downward. Cross beam 4 is prevented from falling completely by heads 15a, the cross sections of which are greater than the outer cross sections of spacer sleeves 14, and therefore each one—in combination with sections that extend radially beyond spacer sleeves 14—forms a contact surface 17 for cross beams 16 that may be falling. The sections that extend beyond spacer sleeves 14 can also be composed, of course, entirely or in part of plain washers disposed between spacer sleeves 14 and heads 15a.

As shown in FIGS. 2, 4 and 5 in particular, in the embodiment described, each stator assembly 1 is equipped with three cross beams 4 and 16, wherein two outer cross beams are attached using first fastening screws 11 to particular stator carrier 9, while a center cross beam 16 is held in contact with stop surface 10 of this stator carrier 9 merely in that stator assemblies 1 are substantially rigid in the x-direction, and therefore, when outer cross beams 4 rest against stop surface 10, center cross beam 16 also lies against assigned stop surface 10. If first fastening screws 11 of one or the other outer cross beam 4 should fail, however, then applicable cross beam 4 will fall downward in the z-direction until center cross beam 16 rests on screw head 15a, and entire stator assembly 1 is prevented from falling further. Dimension A is selected to be so great that the resulting displacement between a falling cross beam 4 and a properly installed cross beam 4 of a subsequent stator assembly 1 is sufficient to be detected visually and/or to be measured automatically using suitable sensors.

Furthermore, in the installed state of stator assemblies 1, all fastening screws 11 and 15 and associated passages 5 and threaded holes 12 preferably extend substantially parallel to the z-axis and/or perpendicularly to first stop surfaces 10.

The securing principle described with reference to FIGS. 2 to 5 can be utilized regardless of the type of carrier 6 used and stator carrier 9 provided thereon. FIG. 6 shows a variant, for example, in which cantilever arms 18 themselves—which are made of concrete—are in the form of stator carriers that extend in the x-direction beyond the length of the associated carriers and are designed as single pieces instead of multiple pieces as compared to the stator carriers composed of individual inserts 9. In contrast to FIGS. 2 to 5, undersides 18a of cantilever arms 18 are therefore in the form of stop surfaces in this case, and are machined by milling or the like at least at the points where cross beams 4, 16 come to rest, in accordance with the desired route such that stator assemblies 1 automatically assume the correct position in three dimensions after attachment using fastening screws 11. Inserts 19 made of steel, which are installed in cantilever arms 18, are used in this case merely to attach fastening screws 11 and 15. For this purpose, inserts 19 are equipped with suitable threaded holes 20 that adjoin the holes for the shanks of fastening screws 11, 15 which extend through cantilever arms 18 and extend to underside 18a.

To prevent the relatively narrow end faces of spacer sleevers 14 from digging into underside 18a made of concrete when fastening screws 15 are tightened, additional plain washers 21 are preferably disposed between underside 18a and cross beams 4, 16 or sleeves 14. Alternatively, it would be possible to install outer cross beams 4, which have a relatively large surface area, or plain washers 21 of that type; in that case, however, they should have a thickness that is greater than the thickness of plain washers 21.

A further variant of the invention, which is shown in FIG. 7, contains a carrier—which is not depicted—made of steel, which comprises a single-piece stator carrier 22 which extends along the entire length thereof, is likewise made of steel, and is machined on underside 22a thereof as required by the route. Alternatively, stator carrier 22 can also comprise individual recesses 23 which are formed in underside 22a, against the bases of which cross beams 4, 16 and spacer sleeves 14 rest. In this case, only the bases of recesses 23 need to be machined as required by the route.

In contrast to the embodiments described so far, FIG. 7 also shows that stator carrier 22 is equipped with continuous holes for fastening screws 11 and 15. In this case, threaded sections of fastening screws 11, 15, which extend upwardly out of stator carrier 22, are used for the installation of nuts 24 which are used to apply a suitable preload to fastening screws 11, 15.

While, in the previously described embodiments, securing means 14, 15 are assigned to a center cross beam 16 which is not used for attachment of stator assemblies 1, FIG. 8 shows a cross beam 25 that is used for attachment as well as securing. Cross beam 25 is at least so long, e.g. in the y-direction, that it can be equipped not only with first fastening screws 11 described with reference to FIGS. 2 to 5, but also with at least one further passage, preferably with two further passages for second fastening screws 15. As shown in FIG. 8, all of these passages are situated one after the other in the y-direction, for example. The two outer passages accommodate spacer sleeves 14 and fastening screws 15, while the two inner passages accommodate only fastening screws 11. As a result, it is possible e.g. to fasten each stator assembly 1 using only two cross beams 25 on stator carrier 9, and to design the two cross beams 25 as shown in FIG. 8, since, in the event of failure of first fastening screws 11, each cross beam 25 can fall only by an amount defined by screw heads 15a.

The invention provides the advantage that fastening screws 15, which are used for the securing means, can have the same dimensions as first fastening screws 11 since the length difference (A) (FIG. 3) is insignificant in this regard. Furthermore, it is possible to also apply second fastening screws 15 with a set preload, even if they are practically unloaded in normal operation. Finally, the production and assembly of the fastening and securing means is extremely simple since it is not necessary to provide special measures such as T-shaped grooves, additional securing projections, or the like, or to account for them in assembly.

The invention is not limited to the embodiments described, which could be modified in various manners. In addition, it is clear that the number of cross beams 4, 16 or 25 used per stator assembly 1 can be selected in a largely arbitrary manner. Likewise, the number of first and/or second fastening screws 11, 15 per cross beam 4, 16, 25 can be selected largely without limit. Furthermore, stator carriers other than those described here may be used. In particular, in a specific case, the stator carrier can be continuous in the x-direction (FIGS. 6 and 7), or single stator carriers interspaced in the x-direction (FIG. 2), which are present only where a cross beam should be fastened or placed. In addition, the stator carriers do not need to extend along the entire length of the cross beams as measured in the y-direction, as shown in FIGS. 4, 5, and 8. Instead, it would be possible to provide a plurality of inserts at the site of every cross beam, or even to assign a separate insert 9 to each individual fastening or securing screw. It is furthermore understood that the passages in the cross beams through which spacer sleeves 14 extend should preferably have an inner diameter that is sufficiently larger than that of passages that only accommodate fastening screws 11, thereby enabling spacer sleeves 14 to be used for a wall thickness that is great enough for the force transmission that is required. Furthermore, spacer sleeves 14 and second fastening screws 15 can be disposed at suitable points on the cross beams other than those shown in the drawings, of course. Finally, it is understood that the various features described may also be used in combinations other than those described and depicted herein.

What is claimed is:

1. A track system for a magnetic levitation vehicle, comprising at least one stator carrier (9, 19, 22), on which cross beams (4) carrying stator assemblies (1) are supported and fastened using first fastening screws (11) which extend through the cross beams (4) and are connected to the stator carrier (9, 19, 22), and comprising securing means assigned to the stator assemblies (1), which permit a defined displacement (A) of at least selected cross beams (16) relative to the stator carrier (9, 19, 22) in the event of failure of the first fastening screws (11), but prevent the selected cross beams (16) from becoming completely detached from the stator carrier (9, 19, 22), characterized in that ^{the} securing means contain spacer sleeves (14) which extend through the selected cross beams (16) and rest via first ends on the stator carrier (9, 19, 22), the lengths (L) of which are greater than the thicknesses (D) of the selected cross beams (16), and second fastening screws (15) having heads (15a), which extend through the spacer sleeves (14) and are likewise connected to the stator carrier (9, 19, 22), and rest on second ends of the spacer sleeves (14) and establish the defined displacement (A) via sections that extend radially beyond the spacer sleeves (14).

2. The track system according to claim 1, characterized in that each stator assembly (1) is equipped with three cross beams (4, 16) which extend in the direction of travel, wherein two outer cross beams (4) are used to fasten the stator assembly (1) to the stator carrier (9, 19, 22) using the first fastening screws (11), while a center cross beam (16) is a selected cross beam, is penetrated by the spacer sleeves (14) and the second fastening screws (15), and, together therewith, form the securing means for the center cross beam (16).

3. The track system according to claim 1, characterized in that each cross beam (4, 16) comprises two passages (5) interspaced transversely to the direction of travel, in which the first fastening screws (11) or the spacer sleeves (14) and the second fastening screws (15) are disposed.

4. The track system according to claim 1, characterized in that a selected cross beam (4) of each stator assembly (1) comprises at least three passages interspaced transversely to the direction of travel, two of which are used to fasten the cross beam (4) to the stator carrier (9) using the first fastening screws (11), while the third passage accommodates one spacer sleeve (14) and a second fastening screw (15) and, together therewith, forms a securing means for this cross beam (4).
